(19) United States
(12) Patent Application Publication
(10) Pub. No.: US 2010/0068462 A1
(43) Pub. Date: Mar. 18, 2010

(54) EVAPORATION ELEMENT AND METHOD FOR THE PRODUCTION THEREOF

(75) Inventors: Ronald Schindele, Gossau (CH); Markus Josef Friedl, Zurich (CH); Daniel M. Gross, Neuenburg (CH); Christoph Maurer, Zuerich (CH)

Correspondence Address: Studebaker & Brackett PC, One Fountain Square, 11911 Freedom Drive, Suite 750, Reston, VA, 20190, US

(73) Assignee: SEFAR AG, Heiden (CH)

(21) Appl. No.: 12/529,161

(22) PCT Filed: Jan. 15, 2008
(86) PCT No.: PCT/EP08/00262

§ 371 Date: Aug. 28, 2009

(30) Foreign Application Priority Data
Mar. 23, 2007 (EP) 07006073.6

(51) Int. Cl. B32B 3/00; B29C 65/00

(52) U.S. Cl. 428/156; 156/60

(57) ABSTRACT

The invention relates to an evaporation element and a method for its production. The evaporation element comprises a diffusion layer with a textile structure for the surface-distribution of a liquid to be evaporated. For a good liquid distribution the textile structure of the diffusion layer comprises a plurality of fibrils that are provided with longitudinal grooves along their exterior.

### TECHNICAL FIELD OF THE INVENTION

The invention relates on the one hand to an evaporation element comprising a diffusion layer, which has a textile structure for the surface-distribution of a liquid to be evaporated.

The invention relates on the other hand to a method for producing an evaporation element with a diffusion layer for the surface-distribution of a liquid to be evaporated, in which the evaporation element is formed of webs that are joined to one another along their longitudinal edges on a seam portion.

### BACKGROUND OF THE INVENTION

A generic evaporation element and a generic method are known from WO 2006/079234 A2. This document also states the diverse possibilities of application of an evaporation element that can range from clothing to large-surface awnings and sun-protection coverings. In such a kind of evaporation element composed of a multi-layered structure liquid is introduced via feed channels from a tank lying above or by means of a pump. In a diffusion layer the liquid is distributed in the textile structure so that it can evaporate over a large surface through a porous evaporation layer. As a result, a pleasant cooling effect is achieved.

An evaporation element for use in connection with motor vehicles is known from U.S. Pat. No. 4,342,203. If the evaporation element is used as a tarpaulin for a motor vehicle for example there is the problem that liquid, caused by gravity, accumulates in deeper lying parts of the evaporation element where it might leak out in a liquid state, whereas other parts are not supplied with liquid at all or to an insufficient degree only.

### SUMMARY OF THE INVENTION

The invention provides an evaporation element and a method for its production, by which a good internal distribution of liquid is rendered possible on larger surfaces, too.

This is achieved on the one hand by an evaporation element having a diffusion layer which has a textile structure for the surface-distribution of a liquid to be evaporated and a blocking layer which is liquid-tight and arranged towards one side of the diffusion layer, wherein the textile structure of the diffusion layer includes a plurality of fibrils that are provided with longitudinal grooves along their exterior, along which liquid can be passed on account of a capillary effect, and on the other hand by a method for producing an evaporation element from webs, which are provided with a diffusion layer for the surface-distribution of a liquid to be evaporated and with a liquid-tight blocking layer, the webs being joined to one another along their longitudinal edges on a seam portion, wherein a feed channel is arranged along the seam portion on the longitudinal edges of the webs for feeding and delivering the liquid to the diffusion layer.

The evaporation element according to the invention is characterized in that the textile structure of the diffusion layer includes a plurality of fibrils that are provided with longitudinal grooves along their exterior.

According to a finding of the invention a capillary effect is of vital importance for the distribution of liquid within the diffusion layer. The capillary effect is also brought about by the intermediate spaces remaining between the individual fibrils, through which the liquid is passed along the longitudinal direction of the fibrils on account of the capillary effect.

In accordance with the invention this capillary effect is intensified by the fact that one or more longitudinal grooves are formed along the exterior of each fibril. Hence, even in the case of a more tightly arranged packing of the fibrils a desired sufficient free space is created within the textile structure, through which liquid is able to flow as a result of the capillary effect. On account of this especially strong capillary effect it is even possible to achieve a distribution of liquid contrary to gravity so that the evaporation element according to the invention is perfect for use in inclined awnings or for clothing. From an economic viewpoint the use of water or a liquid on water basis is suitable. However, other liquids, e.g. based on alcohol, are suitable, too.

According to the invention it is particularly advantageous for the fibrils to have a plurality of longitudinal grooves, the depth and width of which are smaller than 1 μm. These fine longitudinal grooves of the fibrils provide a desired capillary effect especially when interacting in a multifilament yarn with the longitudinal grooves of adjacent fibrils.

In accordance with the invention it is particularly preferred that the fibrils have at least one chamfer-like longitudinal groove, the depth and width of which are greater than 1 μm, preferably ranging between 1 μm and 5 μm. Particularly preferred is a depth and width ranging between 1.5 μm and 2.5 μm. As a rule, each fibril has only one or a few of these relatively large longitudinal grooves, which ensure a sufficient capillary effect even in the case of tightly arranged packing of the fibrils. The longitudinal grooves can be predetermined by a corresponding contour of the spinning nozzles.

According to the invention provision is made for the fibrils to have a diameter ranging from 10 μm to 100 μm, preferably amounting to approximately 50 μm. The fibrils can have an approximately circular or oval shape. However, in accordance with the invention it is particularly preferred that the fibrils are of an approximate kidney-shaped design in cross-section, in which case the relatively large chamfer-like longitudinal groove is surrounded by bulging lateral portions. The length of the individual fibrils can range from a few millimetres up to several kilometres.

Basically, the textile structure can be a non-woven structure, as for example a fleece or so-called stitch-bonded fabrics, in which certain preferred directions of the stitch-bonded fibrils can be set. According to the invention it is especially advantageous that the textile structure of the diffusion layer comprises a fabric with a multifilament yarn that contains the plurality of fibrils. The fabric can be formed exclusively of such multifilament yarns or it can also be formed of a combination with other yarns, in particular monofilament yarns. Within the meaning of the invention multifilament yarns are yarns composed and spun of a plurality of fibrils with the structure of longitudinal grooves. On account of the mutually adjoining exteriors with the groove structure a considerable part of the liquid is passed inside the multifilament yarn in the longitudinal direction of the yarn. In this manner the multifilament yarn provides a particularly strong and directional capillary effect and serves, as it were, as a kind of highway for the passage of liquid.

An especially good capillary effect is attained according to the invention in that the multifilament yarn is composed of 10,000 to 300,000 fibrils per cm² cross-sectional surface and that the mutual distance of the fibrils is predominantly smaller than 2 μm.

In principle, the diffusion layer alone can constitute the evaporation element. A particularly good evaporation and cooling effect is achieved in accordance with the invention in that the textile structure of the diffusion layer has a porous evaporation layer on at least one side. The evaporation layer can be penetrated by the liquid in the diffusion layer in the vaporous state. The porous evaporation layer is a membrane in particular that has a porosity of at least 80% and a pore size of approximately 0.7 μm. The thickness of the membrane can preferably amount to approximately 20 μm, whereby a penetration of the liquid is only possible in the vaporous state. The membrane is formed in a known manner from a plastic material, such as PE or PTFE, or is PU (polyurethane) coagulated. The porous evaporation layer offers protection against dirt and microbial contamination in the diffusion layer. By preference, evaporation layers can be arranged on both sides of the diffusion layer. As a result, an evaporation of the liquid can take place on both sides.

An alternative embodiment of the evaporation element according to the invention resides in the fact that the textile structure of the diffusion layer has a tight blocking layer towards one side. This blocking layer is liquid-tight and practically impermeable to vapour so that evaporation can take place towards one side only. Such a vapour block can be made e.g. from polyurethane with a layer thickness ranging from 0.1 mm to 1 mm. In order for the evaporation element to have an entirely textile-like arrangement, the vapour block is preferably designed in a transparent manner.

Furthermore, according to the invention it is advantageous that at least one protective layer with a fabric is provided. The protective fabric, which can have open or closed meshes, is arranged in particular on top of the sensitive porous evaporation layer in order to protect this sensitive layer against external mechanical influences. The protective fabric can have a mesh width lying between 0.1 mm and 1 mm, in which case an open surface of approximately ⅓ is preferably formed. The yarn diameter can amount to approximately 70 μm. A low sensitivity to dirt is achieved in that use is made of a monofilament yarn that consists in particular of ETFE (Ethylene Tetrafluorethylene). By using one or more protective layers the overall strength of the laminar evaporation element can be increased.

A particularly good capillary effect with a high stability and strength of the evaporation element is attained according to the invention in that the fibrils are made of a material containing PETP (Polyester), PEN (Polyethylene Naphtalate), PP (Polypropylene), PEEK (Polyetheretherketone), LCP (Liquid Crystal Polyester), UHMWPE (Ultra-high Molecular-weight Polyethylene), PTFE (Polytetrafluorethylene), ETFE (Ethylene Tetrafluorethylene), PVDF (Polyvinilidenfluorid) and/or PAC (Polyacrylnitrile). Mineral and/or ceramic materials, as for example S-glass, R-glass or CF (carbon), can also be comprised which are equally employed for fibre production.

According to an advantageous further development of the invention the capillary effect is enhanced by the fact that the fabric of the diffusion layer is designed in a hydrophilic manner. In particular, in the case of a fabric that is as such hydrophobic this can be achieved in that the fibrils, the yarn spun from them and/or the fabric are treated with a hydrophilic substance, in particular by being coated. For example this can be effected through impregnation with tensides or plasma treatment.

An especially compact and hard-wearing structure of the evaporation element is attained according to the invention in that the layers are glued or welded to one another. The gluing can be realized by means of a powdery adhesive or a loose thin fleece, a so-called Spyder Web, so that the permeability between the layers, especially of the diffusion layer and the evaporation layer is still ensured.

The feeding of the liquid to the diffusion layer takes place via longitudinal and/or trans-verse channels. These can be channels of foamed plastic that extend on top of or inside the diffusion layer.

For a good surface distribution of the liquid provision is made according to the invention that the evaporation fabric is formed of webs that are joined to one another along their longitudinal edges, in particular by being welded or glued, and in doing so seam portions are formed and in that feed channels are arranged along the seam portions for feeding and delivering the liquid to the diffusion layer. In this way an evaporation element with a very large surface can be produced, with the feed channels being formed along the seam portions of the individual webs. Therefore, the feed channels do not bring about any additional interference in the laminar evaporation element so that an undisturbed distribution of liquid is rendered possible along the webs.

The method according to the invention for producing an evaporation element is characterized in accordance with the invention in that a feed channel is arranged along the seam portion for feeding and delivering the liquid to the diffusion layer. This results in the advantages described above. The webs can have a width ranging from 1 m to 3 m so that an economic production of large-size tarpaulins with a good liquid distribution is rendered possible, too.

The invention also comprises an evaporation element produced in accordance with this method.

To obtain a good introduction of liquid along the feed channels into the diffusion layer provision is made according to the invention that the evaporation layer is removed at least in sections in the portion of the feed channels. In this manner liquid from the feed channels can pass directly into the diffusion layer so that the liquid can be distributed rapidly in the diffusion layer.

### BRIEF DESCRIPTION OF THE DRAWINGS

In the following the invention is described further by way of preferred embodiments that are illustrated schematically in the drawings, wherein:

FIG. 1 shows a schematic cross-sectional view relating to the structure of an evaporation element according to the invention;

FIG. 2 shows a schematic cross-sectional view of an evaporation element with a feed channel;

FIGS. 3-8 show microscopic pictures of fibrils employed for the evaporation element according to the invention.

### DETAILED DESCRIPTION OF THE INVENTION

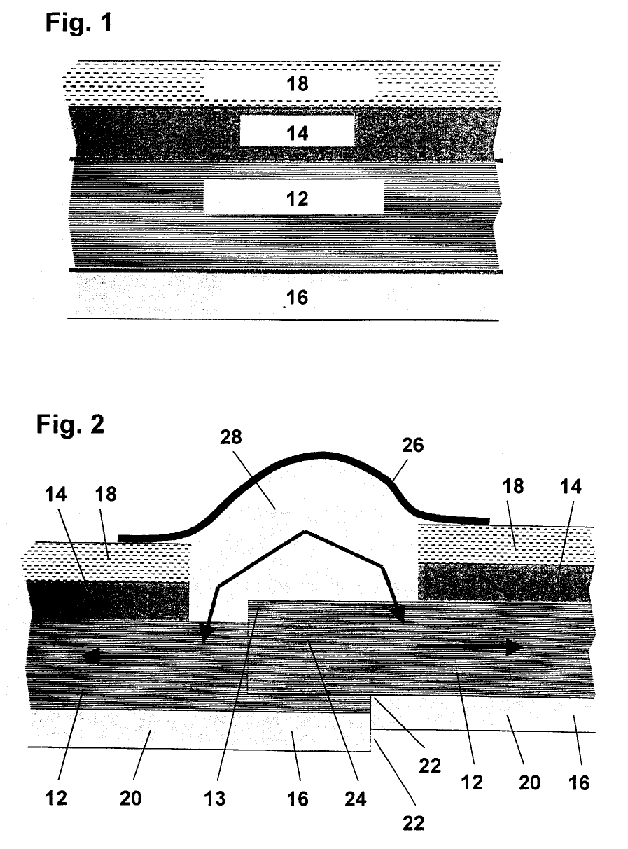

According to FIG. 1 an evaporation element 10 pursuant to the invention has a diffusion layer 12 for distributing the liquid inside the laminar evaporation element 10. The diffusion layer is composed of a multifilament fabric that is woven, at least to a substantial degree, of multifilament yarns. The diffusion layer 12 with a thickness of 0.5 mm also serves to provide mechanical strength.

Bordering below on the diffusion layer 12 is arranged a blocking layer 16. The blocking layer 16 is water-tight and vapour-impermeable. It serves as a protection against dirt and mechanical damage from below and prevents liquid from evaporating in the downward direction. The blocking layer 16 can be colourless or dyed in any chosen colour. The thickness of the layer amounts to approximately 0.15 mm.

Above the diffusion layer 12 a membrane is arranged as a porous evaporation layer 14 that has a thickness of approximately 20 μm. The liquid distributed in the diffusion layer 12 can penetrate the evaporation layer 14 as water vapour but not as liquid, since the said evaporation layer is impermeable to liquid. The evaporation layer 14 also serves to protect the diffusion layer 12 against dirt as well as against contamination caused by algae, bacteria and fungi.

The protective layer 18 arranged on top that has a thickness of 0.12 mm is formed of an open-meshed fabric and serves to protect the sensitive, thin evaporation layer 14.

An evaporation element 10 according to FIG. 2 can be composed of webs 20, each of which has the layer structure according to FIG. 1. Along a longitudinal edge 22 of the blocking layer 16 the webs 20 are placed by butt-jointing. According to FIG. 2 the web 20 on the right side is designed such that the diffusion layer 12 extends beyond the longitudinal edge 22 of the blocking layer 16, whereby a projection 13 of the diffusion layer 12 is formed. The projection 13 overlaps with the adjacent diffusion layer 12 of the other web 20 and is joined thereto, in particular through thermal welding. In the welded seam portion 24 of the projection 13 the diffusion layer 12 is no longer liquid-conductive. In the portion lying above and in the adjacent portion of the two webs 20 joined in this manner the respective evaporation layer 14 and the protective layer 18 are removed in the seam portion 24 so that a free space is formed for the feed channel. By means of an arched covering film 26 extending along the seam portion 24 the free space created in this way for forming a feed channel 28 is covered and sealed in a liquid-tight manner with respect to the surrounding environment. To this end the covering film 26 is joined in a liquid-tight manner to the upper sides of the two webs 20.

The feed channel 28 thus formed is connected on at least one side to a pump or a liquid container so that liquid is able to flow in the feed channel 28 longitudinally to the seam portion 24 and to reach in the diffusion layer 12 on both sides of the seam portion 24 welded in a liquid-tight manner. The flow of the liquid is indicated by black arrows in FIG. 2. The overlapping of the adjacent diffusion layers 12 and their liquid-tight joining in the seam portion 24 brings about a reliable liquid-tight connection of the two adjacent webs 20 in the downward direction towards the blocking layer 16.

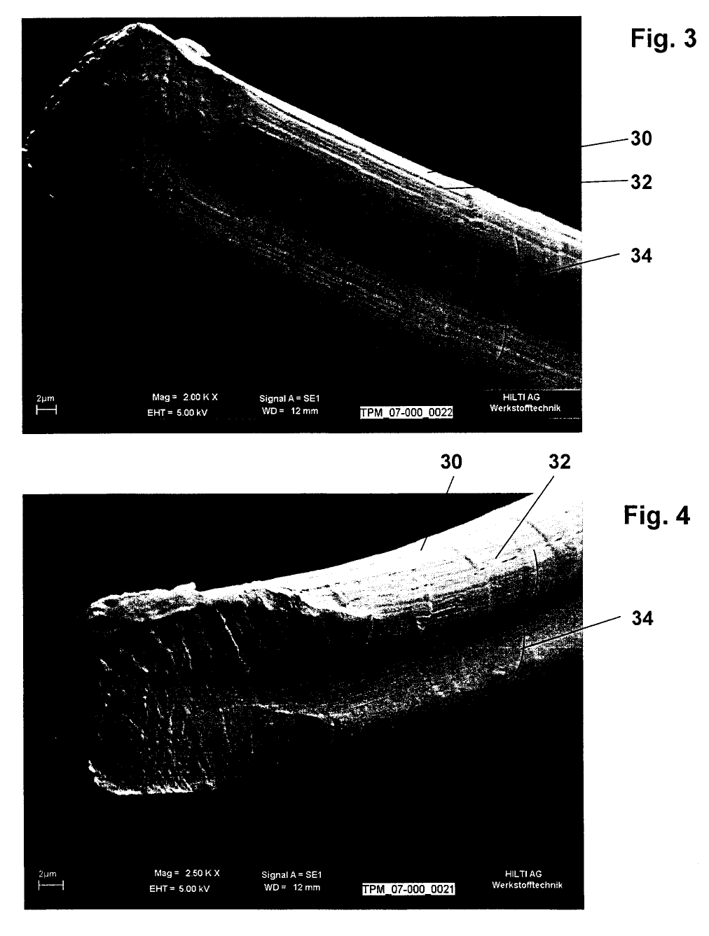

In FIGS. 3 to 4 the structure of the fibrils 30 according to the invention is shown in greater detail. In the present example these have an approximately circular cross-section, with a V-shaped notch extending as a chamfer-like longitudinal groove 34 along a longitudinal axis of the fibril 30. Adjacent to this chamfer-like longitudinal groove 34 further fine longitudinal grooves 32 are formed on the exterior, which, in connection with adjoining fibrils, lead to an excellent capillary effect in a multifilament yarn.

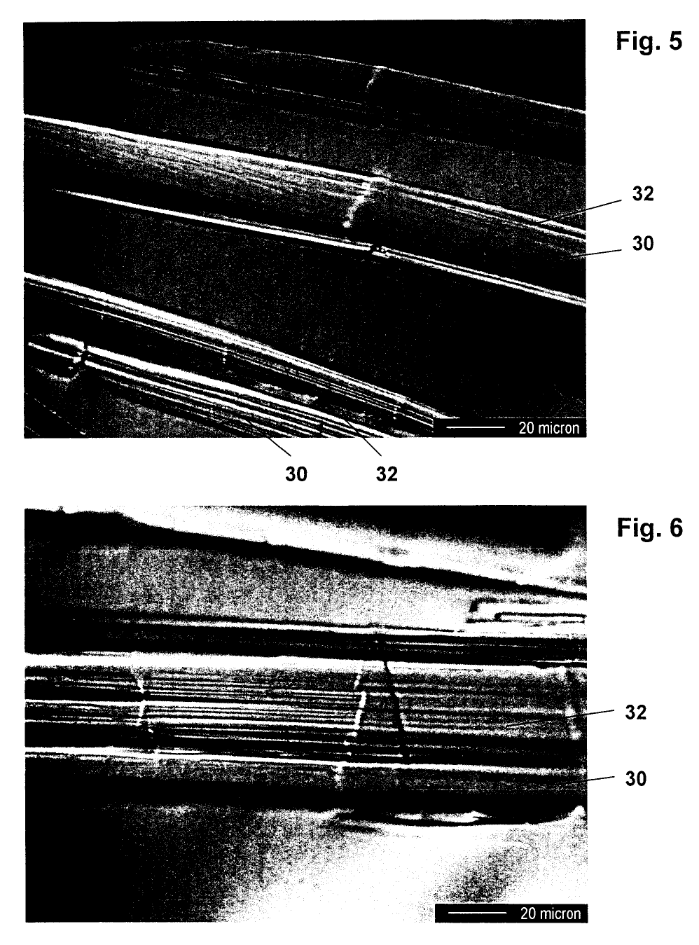

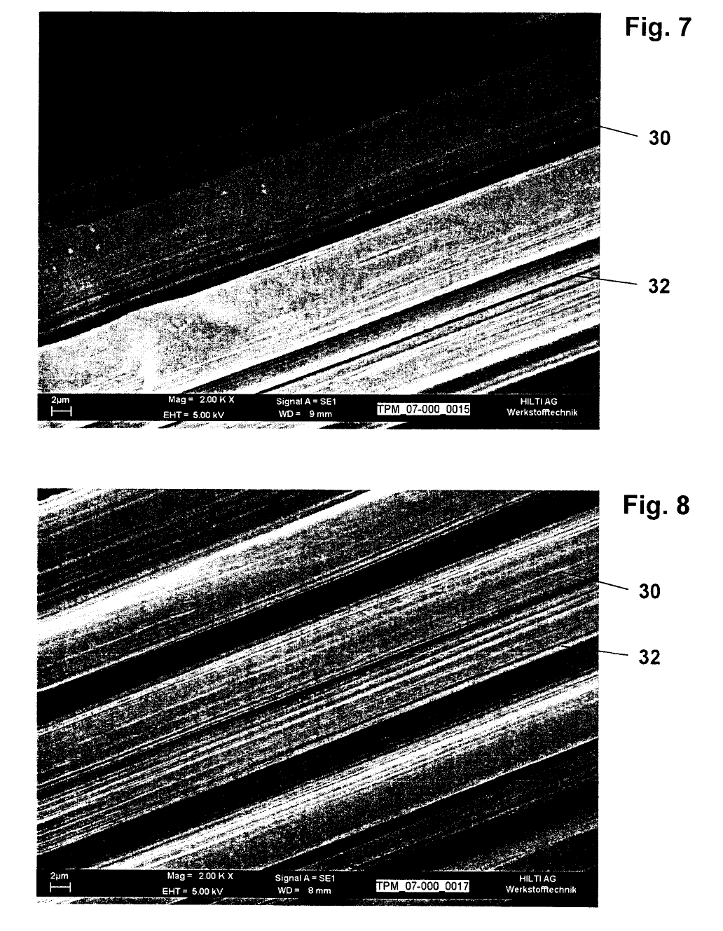

In FIGS. 5 to 8 the said fine longitudinal grooves 32 are shown once more in greater detail by way of different fibrils 30.

1-15. (canceled)

16. An evaporation element comprising:
a diffusion layer having a textile structure for surface-distribution of a liquid to be evaporated; and
a liquid-light blocking layer arranged towards one side of the diffusion layer,
wherein a textile structure of the diffusion layer includes a plurality of fibrils provided with longitudinal grooves along their exterior, along which liquid can be passed on account of a capillary effect.

17. The evaporation element according to claim 16, wherein a depth and width of the longitudinal grooves are smaller than 1 μm.

18. The evaporation element according to claim 16, wherein the fibrils have at least one chamfer-like longitudinal groove, the depth and width of which are greater than 1 μm, preferably ranging between 1 μm and 5 μm.

19. The evaporation element according to claim 16, wherein the fibrils have a diameter ranging from 10 μm to 100 μm, preferably amounting to approximately 50 μm.

20. The evaporation element according to claim 16, wherein the textile structure of the diffusion layer comprises a fabric with a multifilament yarn that contains the plurality of fibrils.

21. The evaporation element according to claim 20, wherein the multifilament yarn is composed of 10,000 to 300,000, preferably of 100,000 to 250,000 fibrils per cm² cross-sectional surface area and the mutual distance of the fibrils is predominantly smaller than 2 μm.

22. The evaporation element according to claim 16, wherein the textile structure of the diffusion layer has a porous evaporation layer on at least one side.

23. The evaporation element according to claim 16, wherein the liquid-tight blocking layer has a layer thickness ranging from 0.1 mm to 1 mm.

24. The evaporation element according to claim 16, further comprising at least one protective layer with a fabric is provided.

25. The evaporation element according to claim 16, wherein the fibrils are made of a material containing at least one of PETP (polyester), PEN (polyethylene naphtalate), PP (polypropylene), PEEK (polyether-etherketone), LCP (liquid crystal polyester), UHMWPE (ultra-high molecular-weight Polyethylene), PTFE (polytetrafluorethylene), ETFE (ethylene tetrafluorethylene), PVDF (polyvinilidenfluorid), PAC (polyacryl-nitril), a mineral material and a ceramic material.

26. The evaporation element according to claim 16, wherein the fabric of the diffusion layer is designed in a hydrophilic manner.

27. The evaporation element according to claim 16, wherein the layers are glued or welded to one another.

28. The evaporation element according to claim 16, wherein the element is formed of webs that are joined to one another along their longitudinal edges, in particular by being welded or glued, forming a seam portion, and a feed channel is arranged along the seam portion for feeding and delivering the liquid to the diffusion layer.

29. A method for producing an evaporation element from webs; comprising
providing the webs with a diffusion layer for the surface-distribution of a liquid to be evaporated and with a liquid-tight blocking layer,
joining the webs to one another along their longitudinal edges on a seam portion, and
arranging a feed channel along the seam portion on the longitudinal edges of the webs for feeding and delivering the liquid to the diffusion layer.

30. The method according to claim 29, wherein a porous evaporation layer is arranged, which can be penetrated by the liquid in the vaporous state and which is removed at least in sections in the portion of the feed channel.
